(19) United States
(12) Patent Application Publication
(10) Pub. No.: US 2020/0141434 A1
(43) Pub. Date: May 7, 2020

(54) METHOD OF MANUFACTURING METAL MEMBER-WELDED STRUCTURE, AND METAL MEMBER-WELDED STRUCTURE

(71) Applicants: Sumitomo Electric Industries, Ltd., Osaka-shi (JP); AutoNetworks Technologies, Ltd., Yokkaichi (JP); Sumitomo Wiring Systems, Ltd., Yokkaichi (JP)

(72) Inventors: Koki SUGIMURA, Osaka-shi (JP); Kazuhiro GOTO, Osaka-shi (JP); Tetsuya KUWABARA, Osaka-shi (JP); Hiroki HIRAI, Yokkaichi (JP); Junichi ONO, Yokkaichi (JP); Tetsuji TANAKA, Yokkaichi (JP); Osamu NAKAYAMA, Yokkaichi (JP); Kazuaki HAMADA, Yokkaichi (JP); Kenji MIYAMOTO, Yokkaichi (JP)

(73) Assignees: Sumitomo Electric Industries, Ltd., Osaka-shi (JP); AutoNetworks Technologies, Ltd., Yokkaichi (JP); Sumitomo Wiring Systems, Ltd., Yokkaichi (JP)

(21) Appl. No.: 16/629,353

(22) PCT Filed: May 30, 2018
(86) PCT No.: PCT/JP2018/020846

§ 371 Date: Jan. 8, 2020

(30) Foreign Application Priority Data
Jul. 25, 2017 (JP) 2017-144031

(51) Int. Cl. F16B 5/08; B23K 26/21

(52) U.S. Cl. CPC F16B 5/08; C22C 21/02; B23K 26/21

(57) ABSTRACT

A method of manufacturing a metal member-welded structure includes: a preparing step of preparing an Al alloy member formed of an Al-based alloy and a Cu member containing Cu as a main component; and a welding step of applying laser from a side of the Al alloy member to the Al alloy member and the Cu member disposed to face each other, and welding the Al alloy member and the Cu member to each other. The Al-based alloy contains, as an additional element, one of: 1 mass % or more and 17 mass % or less of Si; 0.05 mass % or more and 2.5 mass % or less of Fe; and 0.05 mass % or more and 2.5 mass % or less of Mn. A laser applying condition satisfies an output of 550 W or more and a scanning rate of 10 min/sec or more.

### TECHNICAL FIELD

The present invention relates to a method of manufacturing a metal member-welded structure, and a metal member-welded structure.

The present application claims priority based on Japanese Patent Application No. 2017-144031 filed on Jul. 25, 2017, and incorporates the entire description in the Japanese application.

### BACKGROUND ART

As a metal member-welded structure formed by welding an Al member and a Cu member, for example, a structure formed by connecting different types of metals in PTL 1 is known. This structure formed by connecting different types of metals is manufactured by stacking a first metal portion made of copper and a second metal portion made of aluminum on one another, which are then joined to each other by pressurization and heating. This structure formed by connecting different types of metals includes an intermediate portion at a position where the first metal portion and the second metal portion are connected to each other. The intermediate portion includes a first alloy portion, a sea-island structure, and a lamellar structure that are stacked in the direction away from the interface with the first metal portion.

### CITATION LIST

### Patent Literature

PTL 1: Japanese Patent Laying Open No. 2014-97526

### SUMMARY OF INVENTION

A method of manufacturing a metal member-welded structure according to the present disclosure includes:

a preparing step of preparing an Al alloy member made of an Al-based alloy and a Cu member containing Cu as a main component; and

a welding step of applying laser from a side of the Al alloy member to the Al alloy member and the Cu member disposed to face each other, and welding the Al alloy member and the Cu member to each other.

The Al-based alloy contains, as an additional element, one of: 1 mass % or more and 17 mass % or less of Si; 0.05 mass % or more and 2.5 mass % or less of Fe; and 0.05 mass % or more and 2.5 mass % or less of Mn.

A laser applying condition satisfies an output of 550 W or more, and a scanning rate of 10 mm/sec or more.

A first metal member-welded structure according to the present disclosure includes:

an Al alloy member containing 1 mass % or more and 17 mass % or less of Si;

a Cu member containing Cu as a main component; and

a welded portion formed by melting and solidifying each of materials of the Al alloy member and the Cu member.

The welded portion includes a stack structure formed by sequentially stacking
a γ₂ phase containing Cu₉Al₄ and not containing Si,
   a δ phase containing Cu₃Al₂ and not containing Si, and
   a θ phase containing Al₂Cu and Si,

in a direction away from an interface with the Cu member.

A second metal member-welded structure according to the present disclosure includes:

an Al alloy member containing 0.05 mass % or more and 2.5 mass % or less of Fe;

a Cu member containing Cu as a main component; and

a welded portion formed by melting and solidifying each of materials of the Al alloy member and the Cu member.

The welded portion includes a stack structure formed by sequentially stacking
a γ₂ phase containing Cu₉Al₄ and not containing Fe,
a δ phase containing Cu₃Al₂ and Fe,
an inner θ phase containing Al₂Cu and Fe, and
an outer θ phase containing Al₂Cu and not containing Fe,

in a direction away from an interface with the Cu member.

A third metal member-welded structure according to the present disclosure includes:

an Al alloy member containing 0.05 mass % or more and 2.5 mass % or less of Mn;

a Cu member containing Cu as a main component; and

a welded portion formed by melting and solidifying each of materials of the Al alloy member and the Cu member.

The welded portion includes a stack structure formed by sequentially stacking
a γ₂ phase containing Cu₉Al₄ and not containing Mn,
a β phase containing Cu₃Al and Mn, and
a θ phase containing Al₂Cu and not containing Mn,

in a direction away from an interface with the Cu member.

### BRIEF DESCRIPTION OF DRAWINGS

FIG. 1 a cross-sectional view showing a schematic metal member-welded structure according to an embodiment.

FIG. 2 is a microphotograph showing, in an enlarged manner, a portion at and around the interface of a welded portion with a Cu member in a first metal member-welded structure according to the embodiment.

FIG. 3 is a microphotograph showing, in an enlarged manner, a portion of a sea-island structure on the Cu member side in the first metal member-welded structure according to the embodiment.

FIG. 4 is a microphotograph showing, in an enlarged manner, a region surrounded by a solid line rectangle in FIG. 3.

FIG. 5 is a microphotograph showing, in an enlarged manner, a portion at and around a lamellar structure in the first metal member-welded structure according to the embodiment.

FIG. 6 is a microphotograph showing, in an enlarged manner, a portion at and around the interface of a welded portion with a Cu member in a second metal member-welded structure according to the embodiment.

FIG. 7 is a microphotograph showing, in an enlarged manner, a portion of a sea-island structure on the Cu member side in the second metal member-welded structure according to the embodiment.

FIG. 8 is a microphotograph showing, in an enlarged manner, a region surrounded by a solid line rectangle in FIG. 7.

FIG. 9 is a microphotograph showing, in an enlarged manner, a region surrounded by a broken line rectangle in FIG. 7.

FIG. 10 is a microphotograph showing, in an enlarged manner, a portion at and around the interface of a welded portion with a Cu member in a third metal member-welded structure according to an embodiment.

FIG. 11 is a microphotograph showing, in an enlarged manner, a portion of a sea-island structure on the Cu member side in the third metal member-welded structure according to the embodiment.

FIG. 12 is a microphotograph showing, in an enlarged manner, a region surrounded by a solid line rectangle in FIG. 11.

FIG. 13 is a graph showing a result obtained by conducting a line analysis on a portion at and around the interface of a welded portion with a Cu member in a metal member-welded structure of sample No. 1-1.

FIG. 14 is a graph showing a result obtained by conducting a line analysis on a portion at and around the interface of a welded portion with a Cu member in a metal member-welded structure of sample No. 1-2.

FIG. 15 is a graph showing a result obtained by conducting a line analysis on a portion at and around the interface of a welded portion with a Cu member in a metal member-welded structure of sample No. 1-3.

### DETAILED DESCRIPTION

### Problem to be Solved by the Present Disclosure

It is desirable that a metal member-welded structure with excellent joining strength can be manufactured with stability. The above-described metal member-welded structure is excellent in jointing strength, but such a metal member-welded structure with excellent joining strength as described above may not be able to be manufactured depending on the condition.

Thus, an object is to provide a method of manufacturing a metal member-welded structure, by which a metal member-welded structure with excellent joining strength can be manufactured.

Also, another object is to provide a metal member-welded structure with excellent joining strength.

### Advantageous Effect of the Present Disclosure

According to the method of manufacturing a metal member-welded structure of the present disclosure, a metal member-welded structure with excellent joining strength can be manufactured.

The first metal member-welded structure to the third metal member-welded structure according to the present disclosure are excellent in joining strength.

### DESCRIPTION OF EMBODIMENT OF THE PRESENT INVENTION

The embodiments of the present invention will be first listed below for explanation.

(1) A method of manufacturing a metal member-welded structure according to one embodiment of the present invention includes:

a preparing step of preparing an Al alloy member made of an Al-based alloy and a Cu member containing Cu as a main component; and

a welding step of applying laser from a side of the Al alloy member to the Al alloy member and the Cu member disposed to face each other, and welding the Al alloy member and the Cu member to each other.

The Al-based alloy contains, as an additional element, one of: 1 mass % or more and 17 mass % or less of Si; 0.05 mass % or more and 2.5 mass % or less of Fe; and 0.05 mass % or more and 2.5 mass % or less of Mn.

A laser applying condition satisfies an output of 550 W or more, and a scanning rate of 10 mm/sec or more.

According to the above-described configuration, a metal member-welded structure with excellent joining strength can be manufactured with stability. This is because the contents of additional elements satisfy their respective ranges, and the laser output and the laser scanning rate satisfy their respective ranges, to thereby allow manufacturing of a metal member-welded structure including a welded portion having a stack structure that facilitates alleviation of the stress acting on the welded portion (the portion at and around the interface with the Cu member), which will be specifically described later.

When the contents of these additional elements are equal to or greater than their respective lower limit values, a stack structure (described later) can be formed. When the contents of these additional elements are equal to or less than their respective upper limit values, excessive reduction in conductivity can be suppressed.

When the laser output is 550 W or more, the surface of the Cu member can be melted to allow the Al alloy member and the Cu member to be welded to each other.

When the laser scanning rate is 10 mm/sec or more, the scanning rate is not excessively slow, and the time required to weld the Al alloy member and the Cu member is not excessively lengthened, with the result that the productivity can be improved.

(2) As one embodiment of the method of manufacturing a metal member-welded structure, the laser applying condition satisfies an output of 850 W or less, and a scanning rate of 90 mm/sec or less.

When the laser output is 850 W or less, the output is not excessively increased. When the laser scanning rate is 90 mm/sec or less, the scanning rate is not excessively fast, with the result that the surface of the Cu member can be melted.

(3) As one embodiment of the method of manufacturing a metal member-welded structure, the laser is fiber laser.

According to the above-described configuration, the Al alloy member and the Cu member are readily welded to each other.

(4) As one embodiment of the method of manufacturing a metal member-welded structure, the laser is applied to allow penetration through the Cu member.

According to the above-described configuration, a welding mark is formed on one side of the Cu member on the side opposite to the Al alloy member. Accordingly, it can be readily distinguished that the Al alloy member and the Cu member are welded to each other. It is considered that, when Cu is melted enough to allow penetration through the Cu member, fragile Al₂Cu is formed to thereby reduce the joining strength. However, when the above-mentioned Al alloy member is prepared, to which laser is applied on the above-mentioned laser applying condition, fragile Al₂Cu can be reduced in size. Thereby, reduction in joining strength can be suppressed, which allows manufacturing of a metal member-welded structure having the joining strength comparable to that in the case where a part of the Cu member is melted.

(5) A first metal member-welded structure according to one embodiment of the present invention includes:

an Al alloy member containing 1 mass % or more and 17 mass % or less of Si;

a Cu member containing Cu as a main component; and

a welded portion formed by melting and solidifying each of materials of the Al alloy member and the Cu member.

The welded portion includes a stack structure formed by sequentially stacking
a γ₂ phase containing Cu₉Al₄ and not containing Si,
a δ phase containing Cu₃Al₂ and not containing Si, and
a θ phase containing Al₂Cu and Si,

in a direction away from an interface with the Cu member.

The above-described configuration allows excellent joining strength between the Al alloy member and the Cu member. This is because the welded portion between the Al alloy member and the Cu member includes a stack structure at an interface with the Cu member, so that reduction in joining strength at the interface between the Cu member and the welded portion can be suppressed.

(6) A second metal member-welded structure according to one embodiment of the present invention includes:

an Al alloy member containing 0.05 mass % or more and 2.5 mass % or less of Fe;

a Cu member containing Cu as a main component; and

a welded portion formed by melting and solidifying each of materials of the Al alloy member and the Cu member.

The welded portion includes a stack structure formed by sequentially stacking
a γ₂ phase containing Cu₉Al₄ and not containing Fe,
a δ phase containing Cu₃Al₂ and Fe,
an inner θ phase containing Al₂Cu and Fe, and
an outer θ phase containing Al₂Cu and not containing Fe,

in a direction away from an interface with the Cu member.

The above-described configuration allows excellent joining strength between the Al alloy member and the Cu member as in the first metal member-welded structure.

(7) A third metal member-welded structure according to one embodiment of the present invention includes:

an Al alloy member containing 0.05 mass % or more and 2.5 mass % or less of Mn;

a Cu member containing Cu as a main component; and

a welded portion formed by melting and solidifying each of materials of the Al alloy member and the Cu member.

The welded portion includes a stack structure formed by sequentially stacking
a γ₂ phase containing Cu₉Al₄ and not containing Mn,
a β phase containing Cu₃Al and Mn, and
a θ phase containing Al₂Cu and not containing Mn,

in a direction away from an interface with the Cu member.

The above-described configuration allows excellent joining strength between the Al alloy member and the Cu member as in the first metal member-welded structure.

(8) As one embodiment of the first metal member-welded structure, the welded portion includes a sea-island structure including:

a plurality of island portions containing Al₂Cu and Si, and distributed on a side opposite to the interface with respect to the stack structure; and

a sea portion containing pure Al and Si, and interposed among the plurality of island portions.

According to the above-described configuration, the surface area of each island portion in the welded portion is increased by the sea-island structure, so that the stress acting on the welded portion (at and around the interface with the Cu member) is readily distributed, thereby allowing further excellent joining strength between the Al alloy member and the Cu member.

(9) As one embodiment of the first metal member-welded structure in which the welded portion includes the sea-island structure, a distance between the island portions is 10 μm or less.

When the above-mentioned distance is 10 μm or less, the distance between the island portions is not excessively wide, so that cracks are less likely to linearly propagate, thereby allowing further excellent joining strength between the Al alloy member and the Cu member.

(10) As one embodiment of the second metal member-welded structure, the welded portion includes a sea-island structure including:

a plurality of coarse island portions containing Al₂Cu and Fe, and distributed on a side opposite to the interface with respect to the stack structure;

a plurality of minute island portions containing pure Al and distributed among the plurality of coarse island portions; and

a three-dimensional mesh-like sea portion containing Al₂Cu and Fe, and interposed between the coarse island portion and the minute island portion.

According to the above-described configuration, the surface area of each coarse island portion in the welded portion is increased by the sea-island structure, so that the stress acting on the welded portion is readily distributed, thereby allowing further excellent joining strength between the Al alloy member and the Cu member.

(11) As one embodiment of the third metal member-welded structure, the welded portion includes a sea-island structure including:

a plurality of coarse island portions containing Al₂Cu and Mn, and distributed on a side opposite to the interface with respect to the stack structure;

a plurality of minute island portions containing pure Al and distributed among the plurality of coarse island portions; and

a three-dimensional mesh-like sea portion containing Al₂Cu and Mn, and interposed between the coarse island portion and the minute island portion.

According to the above-described configuration, the surface area of each coarse island portion in the welded portion is increased by the sea-island structure, so that the stress acting on the welded portion is readily distributed, thereby allowing further excellent joining strength between the Al alloy member and the Cu member.

(12) As one embodiment of the above-described second and third metal member-welded structures in which the welded portion has the sea-island structure, a distance between the coarse island portions is 10 μM or less.

When the above-mentioned distance is 10 μm or less, the distance between the coarse island portions is not excessively wide, so that cracks are less likely to linearly propagate, thereby allowing further excellent joining strength between the Al alloy member and the Cu member.

(13) As one embodiment of the above-described first to third metal member-welded structures in which the welded portion has the sea-island structure, the welded portion has a lamellar structure containing Al₂Cu and pure Al on a side opposite to the stack structure with respect to the sea-island structure.

According to the above-described configuration, the surface area of Al₂Cu in the welded portion is increased by the lamellar structure, so that the stress acting on the welded portion is readily distributed, thereby allowing further excellent joining strength between the Al alloy member and the Cu member.

(14) As one embodiment of the above-mentioned first to third metal member-welded structures, the welded portion penetrates through the Cu member.

According to the above-described configuration, a welding mark is formed on the surface of the Cu member on the side opposite to the Al alloy member. Accordingly, it can be readily distinguished that the Al alloy member and the Cu member are welded to each other. Also, the joining strength is excellent to the extent comparable to that in the case where a part of the Cu member is melted.

### DETAILS OF EMBODIMENTS OF THE PRESENT INVENTION

The details of the embodiments of the present invention will be described below. The embodiments will be described sequentially in the order of: a method of manufacturing a metal member-welded structure, and a metal member-welded structure. The metal member-welded structure will be described sequentially in the order of the first metal member-welded structure, the second metal member-welded structure and the third metal member-welded structure in accordance with the types of the additional elements in the Al alloy member.

[Method of Manufacturing Metal Member-Welded Structure]

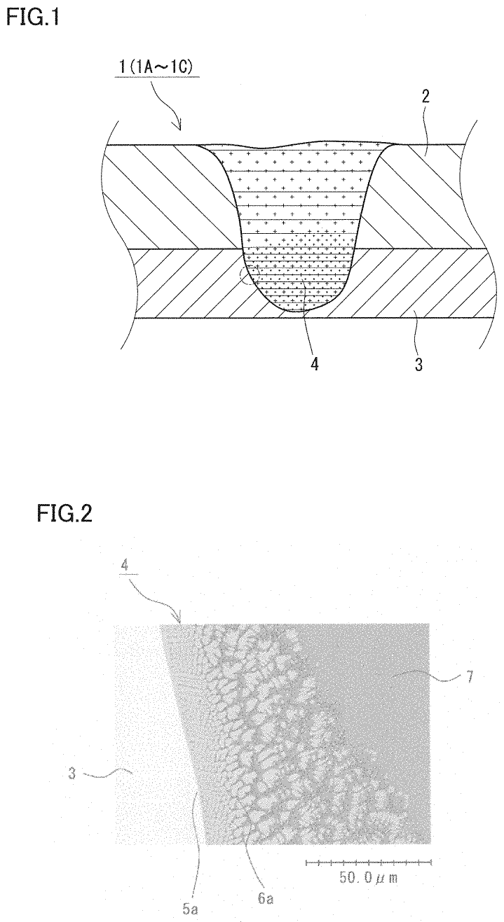

Herein, a method of manufacturing a metal member-welded structure according to an embodiment will be described appropriately with reference to FIG. 1. The method of manufacturing a metal member-welded structure according to the embodiment includes: a preparing step of preparing an Al alloy member 2 and a Cu member 3; and a welding step of applying laser to Al alloy member 2 and Cu member 3 so as to be welded to each other. The method of manufacturing a metal member-welded structure has one characteristic feature that Al alloy member 2 having a specific composition is prepared in the preparing step, and that laser is applied on a specific applying condition in the welding step. The details of each of the steps will be hereinafter described. In the following description, the side to which laser is applied is defined as a front surface (the upper side in FIG. 1), the side opposite to the front surface is defined as a back surface (the lower side in FIG. 1), and the front-back direction is defined as a thickness direction.

[Preparing Step]

In the preparing step, Al alloy member 2 and Cu member 3 are prepared.

(Al Alloy Member)

Al alloy member 2 is made of an Al-based alloy. The Al-based alloy contains Al (aluminum) as a main component, and one element of Si (silicon), Fe (iron), and Mn (manganese) as an additional element. This Al-based alloy is allowed to contain inevitable impurities.

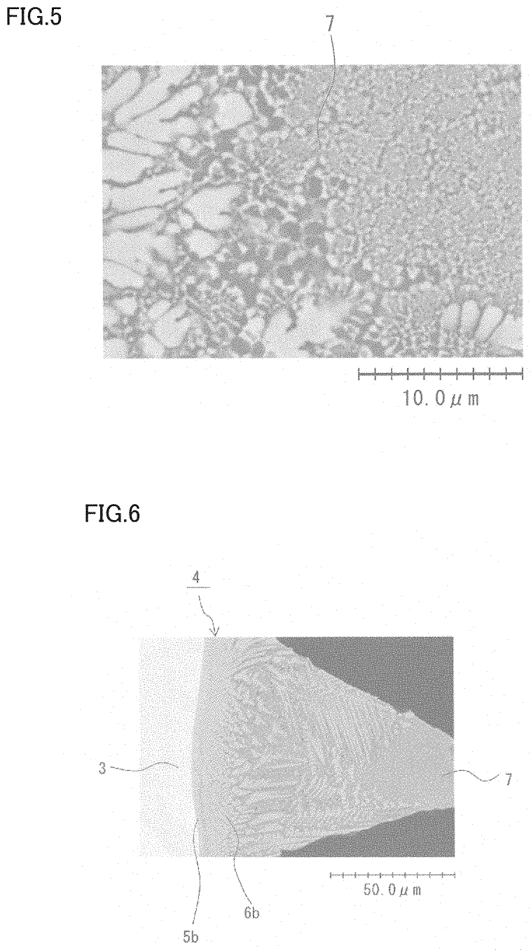

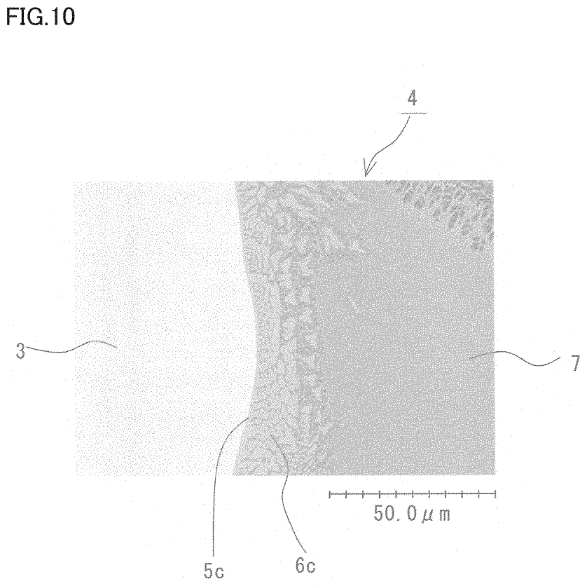

The content of Si is 1 mass % or more and 17 mass % or less, preferably 2.5 mass % or more and 15 mass % or less, and further preferably 4 mass % or more and 13 mass % or less. The content of Fe is 0.05 mass % or more and 2.5 mass % or less, preferably 0.25 mass % or more and 2 mass % or less, and further preferably 0.5 mass % or more and 1.5 mass % or less. The content of Mn is 0.05 mass % or more and 2.5 mass % or less, preferably 0.25 mass % or more and 2 mass % or less, further preferably 0.5 mass % or more and 1.5 mass % or less. When the contents of these additional elements are equal to or greater than their respective lower limit values, a welded portion 4 including a stack structure 5a (5b, 5c) that will be described later with reference to FIG. 2 (FIG. 6 and FIG. 10) can be formed. When the contents of these additional elements are equal to or less than their respective upper limit values, excessive reduction in conductivity can be suppressed.

The shape of Al alloy member 2 can be selected as appropriate and representatively has a plate shape. The thickness of Al alloy member 2 can be selected as appropriate and, for example, is 0.2 mm or more and 1.2 mm or less, further 0.25 mm or more and 0.9 mm or less, and particularly 0.3 mm or more and 0.6 mm or less.

(Cu Member)

Cu member 3 contains Cu (copper) as a main component, which means pure copper and a Cu-based alloy. Cu member 3 is allowed to contain inevitable impurities. The additional elements of the Cu-based alloy are one or more elements selected from Si, Fe, Mn, Ti, Mg, Sn, Ag, In, Sr, Zn, Ni, Al, and P, for example. The contents of these additional elements can be selected as appropriate to fall within ranges in which no excessive reduction in conductivity occurs. The total content of the additional elements is preferably 0.001 mass % or more and 0.1 mass % or less, further preferably 0.005 mass % or more and 0.07 mass % or less, and particularly preferably 0.01 mass % or more and 0.05 mass % or less, for example.

The shape of Cu member 3 can be selected as appropriate and representatively has a plate shape as with Al alloy member 2. The thickness of Cu member 3 can be selected as appropriate and, for example, is 0.15 mm or more and 0.6 mm or less, further 0.25 mm or more and 0.5 mm or less, and particularly 0.35 mm or more and 0.4 mm or less.

[Welding Step]

In the welding step, Al alloy member 2 and Cu member 3 are welded to each other. This welding is performed in such a manner that Al alloy member 2 and Cu member 3 are disposed to face each other, to which laser is applied from the Al alloy member 2 side. This leads to manufacturing of a metal member-welded structure 1 (1A to 1C) in which Al alloy member 2 and Cu member 3 are joined to each other by welded portion 4 formed by melting and solidifying the materials of Al alloy member 2 and Cu member 3.

Laser is applied to thereby melt from the front surface to the back surface of Al alloy member 2 to which laser is applied, and also melt at least a part of an area of Cu member 3 that faces the melted portion of Al alloy member 2. Depending on the laser applying condition, the front surface and the back surface of Cu member 3 are melted in the same manner as with Al alloy member 2. In this case, welded portion 4 that has been melted and solidified penetrates through Cu member 3. When welded portion 4 penetrates through Cu member 3, a welding mark (not shown in the figure) is formed on the back surface of Cu member 3. Thus, it can be readily distinguished that Al alloy member 2 and Cu member 3 are welded to each other. It was considered that melting of Cu enough to allow penetration through Cu member 3 leads to formation of fragile Al₂Cu (described later), thereby deteriorating the joining strength. However, when Al alloy member 2 is prepared and applied with laser on a specific applying condition, fragile Al₂Cu can be reduced in size. This consequently allows manufacturing of metal member-welded structure 1 having the joining strength comparable to that in the case where a part of Cu member 3 is melted.

Laser only has to be a type that allows Al alloy member 2 and Cu member 3 to be melted and welded to each other. The type of the laser may include solid-state laser for which a medium is a solid, and is preferably one type selected from fiber laser, YAG laser, and YVO4 laser, for example. These lasers readily allow Al alloy member 2 and Cu member 3 to be welded to each other. These lasers also include known lasers, for which mediums are doped with various materials. In other words, as to the above-mentioned fiber laser, a fiber core as its medium is doped with a rare earth element and the like, or doped with Yb and the like, for example. As to the YAG laser, its medium may be doped with Nd, Er and the like. As to the YVO4 laser, its medium may be doped with Nd and the like.

The laser applying condition can be selected as appropriate in accordance with the thickness of Al alloy member 2 or Cu member 3, the thickness of welded portion 4, the type of the laser, and the like. It is preferable that the laser applying condition is set enough to allow penetration through Cu member 3.

The laser output is 550 W or more. When the laser output is 550 W or more, the surface of Cu member 3 can be melted to allow Al alloy member 2 and Cu member 3 to be welded to each other. It is preferable that the laser output is 850 W or less. When the laser output is 850 W or less, an excessively high output can be prevented. The laser output is preferably 570 W or more and 830 W or less, and further preferably 600 W or more and 800 W or less.

The laser scanning rate is 10 mm/sec or more. When the laser scanning rate is 10 mm/sec or more, the scanning rate is not excessively slow and the time required to weld Al alloy member 2 and Cu member 3 is not excessively lengthened, with the result that the productivity can be improved. The laser scanning rate is preferably 90 mm/sec or less. When the laser scanning rate is 90 mm/sec or less, the scanning rate is not excessively fast, with the result that the surface of Cu member 3 can be melted. The laser scanning rate is preferably 15 mm/sec or more and 60 mm/sec or less, and further preferably 20 mm/sec or more and 30 mm/sec or less. The laser scanning direction can be selected as appropriate and is defined as the direction perpendicular to the plane of the sheet of paper showing FIG. 1.

It is preferable that the assist gas used during laser application is nitrogen gas. It is preferable that the direction in which assist gas is applied is orthogonal to the direction in which laser is applied.

[Functions and Effects]

According to the method of manufacturing a metal member-welded structure, a metal member-welded structure with excellent joining strength can be manufactured with stability.

[First Metal Member-Welded Structure]

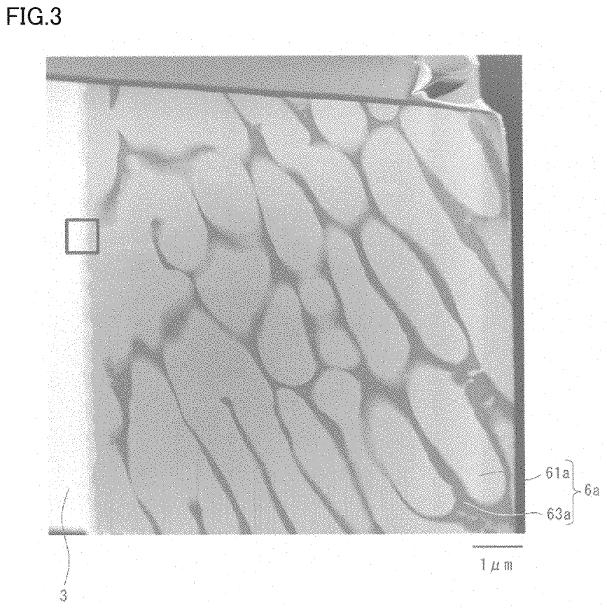

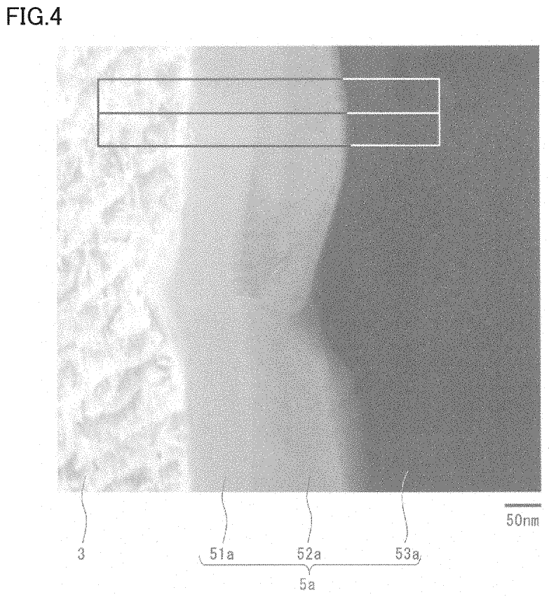

Referring to FIGS. 1 to 5, a first metal member-welded structure 1A will be hereinafter described. First metal member-welded structure 1A includes an Al alloy member 2, a Cu member 3, and a welded portion 4 that joins Al alloy member 2 and Cu member 3 (FIG. 1). First metal member-welded structure 1A can be manufactured by the method of manufacturing a metal member-welded structure as described above. First metal member-welded structure 1A has one characteristic feature in that welded portion 4 includes a stack structure 5a (FIG. 2) having a specific composition and a specific structure. FIG. 2 is a microphotograph showing, in an enlarged manner, a portion surrounded by a broken line circle in FIG. 1 and also showing, in an enlarged manner, a portion at and around the interface of welded portion 4 with Cu member 3. FIG. 3 is a microphotograph showing, in an enlarged manner, a portion of a sea-island structure 6a in FIG. 2 on the Cu member 3 side. FIG. 4 is a transmission electron microscope photograph showing, in an enlarged manner, a region surrounded by a solid line rectangle in FIG. 3. FIG. 5 is a microphotograph showing, in an enlarged manner, a portion at and around lamellar structure 7 in FIG. 2.

[Al Alloy Member]

Al alloy member 2 contains Al as a main component and is formed of an Al-based alloy containing Si as an additional element (FIG. 1). This Al alloy member 2 is allowed to contain inevitable impurities. The content of Si is as described above and 1 mass % or more and 17 mass % or less. The suitable content of Si and the suitable thickness of Al alloy member 2 are as described above. The thickness of Al alloy member 2 is assumed to be a thickness of a portion of Al alloy member 2 excluding welded portion 4.

[Cu Member]

Cu member 3 contains Cu as a main component, which means pure copper and a Cu-based alloy. The composition of Cu member 3 is as described in the above manufacturing method. In this case, Cu member 3 is pure copper. In this case, Cu member 3 has a plate shape and its suitable thickness is as described above. As in Al alloy member 2, the thickness of Cu member 3 is assumed to be a thickness of a portion of Cu member 3 excluding welded portion 4.

[Welded Portion]

Welded portion 4 serves to join Al alloy member 2 and Cu member 3 and is formed by melting and solidifying the materials of Al alloy member 2 and Cu member 3. In other words, the main constituent elements of welded portion 4 are Al, Si, and Cu in this example. The region in which welded portion 4 is formed in the thickness direction of metal member-welded structure 1A is defined as a region extending from the surface of Al alloy member 2 to at least a part of Cu. In other words, welded portion 4 penetrates through Al alloy member 2 between its front surface and its back surface. It is preferable that this region in which welded portion 4 is formed extends to the back surface of Cu member 3. In other words, it is preferable that welded portion 4 penetrates through Cu member 3 between its front surface and its back surface. This leads to formation of a welding mark on the back surface of Cu member 3. Thus, it can readily be distinguished that Al alloy member 2 and Cu member 3 are welded to each other. This welded portion 4 includes a stack structure 5a, a sea-island structure 6a, and a lamellar structure 7 (FIGS. 2 to 5).

(Stack Structure)

Stack structure 5a is formed at the interface with Cu member 3 and formed by stacking a γ₂ phase 51a, a δ phase 52a and a θ phase 53a sequentially in this order in the direction away from the interface (the direction opposite to Cu member 3) (FIG. 4). By including stack structure 5a having thin phases, reduction in joining strength of the interface between Cu member 3 and welded portion 4 can be suppressed. Thereby, the joining strength between Al alloy member 2 and Cu member 3 is more excellent than that in the case where stack structure 5a has thick phases. In particular, excellent joining strength is achieved by including two phases (γ₂ phase 51a and δ phase 52a in this example) between Cu member 3 and θ phase 53a.

<γ₂ Phase>

First, γ₂ phase 51a is formed in a layered shape immediately above Cu member 3. This γ₂ phase 51a contains Cu₉Al₄ and does not contain Si. The thickness of γ₂ phase 51a is 0.05 μm or more and 0.5 μm or less, and further 0.1 μm or more and 0.3 μm or less.

<δ Phase>

Then, δ phase 52a is formed in a layered shape immediately above γ₂ phase 51a. This δ phase 52a contains Cu₃Al₂ and does not contain Si. The thickness of δ phase 52a is 0.1 μm or more and 0.5 μm or less, and further 0.15 μm or more and 0.3 μm or less.

<θ Phase>

Then, θ phase 53a is formed immediately above δ phase 52a. This θ phase 53a includes: a layered portion formed on the δ phase 52a side; and a peninsula-like portion extending from a portion immediately above the layered portion to the side opposite to δ phase 52a. This θ phase 53a contains Al₂Cu and Si. This θ phase 53a contains Al₂Cu as a main component. The content of Si is 0.5 mass % or more and 1.8 mass % or less, and further 0.8 mass % or more and 1.5 mass % or less.

The composition of each phase can be analyzed by an EDX (energy dispersive X-ray analyzer). The thickness of each of γ₂ phase 51a and δ phase 52a is calculated by observing the cross section of welded portion 4 by a TEM (transmission electron microscope) and conducting a line analysis by the EDX in the direction away from the interface of welded portion 4 with Cu member 3. In this case, the thickness of each of γ₂ phase 51a and δ phase 52a is an average of the thicknesses calculated in the analyses conducted on the conditions that the number of fields of view is one or more and the number of line analyses in each of the fields of view is three or more. The cross section is defined as a cross section (a transverse section) taken along the direction (the horizontal direction on the plane of the sheet of paper showing FIG. 1) orthogonal to each of the thickness direction of metal member-welded structure 1A and the longitudinal direction (the direction perpendicular to the plane of sheet of paper showing FIG. 1) of welded portion 4. The magnification of each field of view is set at 200000 times, and the size of each field of view is set at 0.65 μm×0.65 μm.

(Sea-Island Structure)

Sea-island structure 6a is formed on the side opposite to the above-mentioned interface (on the Cu member 3 side) with respect to stack structure 5a (FIG. 3). This sea-island structure 6a includes a plurality of island portions 61a and a sea portion 63a. The surface area of each island portion 61a in welded portion 4 is increased by this sea-island structure 6a, so that the stress acting on welded portion 4 is readily distributed, thereby allowing further excellent joining strength between Al alloy member 2 and Cu member 3.

<Island Portion>

Island portions 61a are distributed on the side opposite to Cu member 3 with respect to stack structure 5a. Each island portion 61a contains Al₂Cu and Si. Island portion 61a contains Al₂Cu as a main component. The content of Si is 0.3 mass % or more and 1.8 mass % or less, and further 0.5 mass % or more and 1.5 mass % or less. It is preferable that Si is dissolved in Al₂Cu. The content of Si can be analyzed by the EDX as with the composition analysis for stack structure 5a. The content of Si is defined as an average of the contents of Si in all island portions 61a existing in two or more fields of view. The cross section is defined as described above. The magnification of each field of view is set at 10000 times, and the size of each field of view is set at 10 μm×10 μm.

The size of island portion 61a is 5 μm² or more and 30 μm² or less, and further 10 μm² or more and 20 μm² or less. Island portion 61a has a size equal to an average of the areas of all island portions 61a that exist in two or more fields of view along the cross section of welded portion 4. The area of island portion 61a is calculated by a commercially available image analysis software. The cross section is defined as described above. The magnification of each field of view is set at 10000 times, and the size of each field of view is set at 10 μm×10 μm.

It is preferable that the distance between island portions 61a is 10 μm or less. This prevents an excessively long distance between island portions 61a, so that linear propagation of cracks can be suppressed. The distance between island portions 61a is further preferably 7 μm or less and particularly preferably 5 μm or less. The lower limit of the distance between island portions 61a is 0.5 μm or more, for example. This prevents excessively narrow distance between island portions 61a, so that the stress acting on welded portion 4 (the portion at an around the interface with Cu member 3) is readily distributed. The distance between island portions 61a means the length between the center points of island portions 61a along the direction orthogonal to the interface of welded portion 4 with Cu member 3. In this case, in two or more fields of view, five or more imaginary lines orthogonal to the above-mentioned interface are set for each field of view. Then, the length of the distance between island portions 61a on each imaginary line is measured to obtain an average of the lengths on all of the imaginary lines. The cross section and the field of view are defined as described above.

<Sea Portion>

Sea portion 63a is interposed among island portions 61a. This sea portion 63a is formed in a three-dimensional mesh-like shape. This sea portion 63a is interposed also between island portion 61a and θ phase 53a of stack structure 5a. Sea portion 63a contains pure Al and Si. This sea portion 63a contains pure Al as a main component. The content of Si is 0.5 mass % or more and 15 mass % or less, and further 0.7 mass % or more and 13 mass % or less. It is preferable that Si is dissolved in pure Al.

(Lamellar Structure)

Lamellar structure 7 is formed on the side opposite to stack structure 5a with respect to sea-island structure 6a (FIGS. 2 and 5). This lamellar structure 7 is formed of an Al₂Cu layer made of Al₂Cu and a pure Al layer made of pure Al. The surface area of the Al₂Cu layer in welded portion 4 is increased by lamellar structure 7, so that the stress acting on welded portion 4 is readily distributed. In this lamellar structure 7, it is more preferable that the Al₂Cu layer and the pure Al layer are disposed at random such that the Al₂Cu layer and the pure Al layer are stacked in various directions than that the Al₂Cu layer and the pure Al layer are stacked in one direction. Thereby, the stress acting on welded portion 4 is further more readily distributed.

[Second Metal Member-Welded Structure]

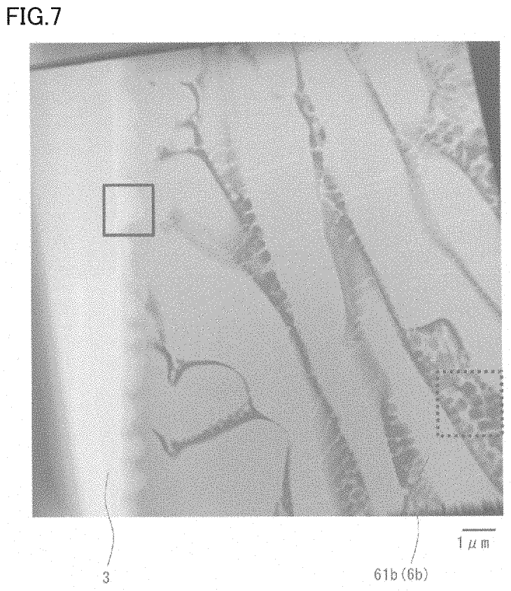

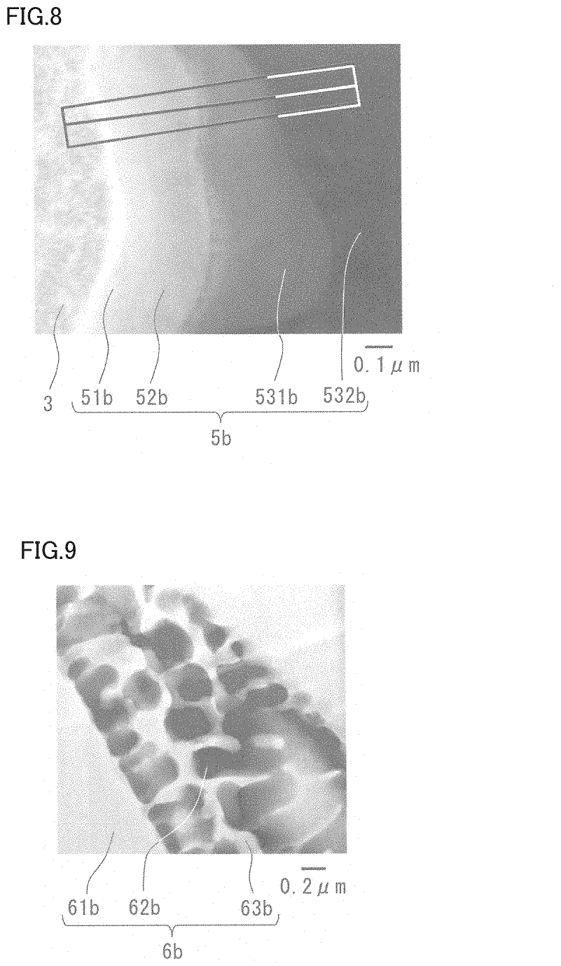

Referring to FIG. 1 and FIGS. 6 to 9, a second metal member-welded structure 1B will be hereinafter described. Second metal member-welded structure 1B is the same as first metal member-welded structure 1A in that it includes Al alloy member 2, Cu member 3, and welded portion 4, but is different from first metal member-welded structure 1A in composition of Al alloy member 2 and in composition and structure of welded portion 4. The following description will be focused on the differences from first metal member-welded structure 1A, and the description of the same configuration and the same effects will not be repeated. The same is also applied to a third metal member-welded structure 1C, which will be described later. Second metal member-welded structure 1B can be manufactured by the above-described method of manufacturing a metal member-welded structure in the same manner as with first metal member-welded structure 1A. As in FIG. 2, FIG. 6 is a microphotograph showing, in an enlarged manner, a portion surrounded by a broken line circle in FIG. 1 and also showing, in an enlarged manner, a portion at and around the interface of welded portion 4 with Cu member 3. FIG. 7 is a microphotograph showing, in an enlarged manner, a portion of sea-island structure 6b in FIG. 6 on the Cu member 3 side. FIG. 8 is a transmission electron microscope photograph showing, in an enlarged manner, a region surrounded by a solid line rectangle in FIG. 7. FIG. 9 is a transmission electron microscope photograph showing, in an enlarged manner, a region surrounded by a broken line rectangle in FIG. 7.

[Al Alloy Member]

Al alloy member 2 contains Al as a main component, and is formed of an Al-based alloy containing Fe as an additional element (FIG. 1). This Al alloy member 2 is allowed to contain inevitable impurities. The content of Fe is as described above and is 0.05 mass % or more and 2.5 mass % or less, preferably 0.25 mass % or more and 2 mass % or less, and further preferably 0.5 mass % or more and 1.5 mass % or less.

[Welded Portion]

Welded portion 4 includes a stack structure 5b, a sea-island structure 6b, and a lamellar structure 7 as with first metal member-welded structure 1A (FIG. 6). This welded portion 4 is different from first metal member-welded structure 1A in that the main constituent elements of welded portion 4 are Al, Fe, and Cu, and also in composition and structure of each of stack structure 5b and sea-island structure 6b.

(Stack Structure)

Stack structure 5b is formed by stacking a γ₂ phase 51b, a δ phase 52b, an inner θ phase 531b, and an outer θ phase 532b sequentially in the direction away from the interface with Cu member 3 (FIG. 8).

<γ₂ Phase>

First, γ₂ phase 51b is formed in a layered shape immediately above Cu member 3. This γ₂ phase 51b contains Cu₉Al₄ and does not contain Fe. The thickness of γ₂ phase 51b is 0.05 μm or more and 0.5 μm or less, and further 0.1 μm or more and 0.3 μm or less.

<δ Phase>

Then, δ phase 52b is formed in a layered shape immediately above γ₂ phase 51b. This δ phase 52b contains Cu₃Al₂ and Fe. This δ phase 52b contains Cu₃Al₂ as a main component. The content of Fe is 0.8 mass % or more and 2.2 mass % or less, and further 1.2 mass % or more and 1.8 mass % or less. The thickness of δ phase 52b is 0.05 μm or more and 0.5 μm or less, and further 0.1 μm or more and 0.3 μm or less.

<Inner θ Phase>

Inner θ phase 531b is formed immediately above δ phase 52b. This inner θ phase 531b includes: a layered portion formed on the δ phase 52b side; and a peninsula-like portion extending from a part immediately above the layered portion to the side opposite to δ phase 52b. Inner θ phase 531b contains Al₂Cu and Fe. This inner θ phase 531b contains Al₂Cu as a main component. The content of Fe is 0.8 mass % or more and 2.2 mass % or less, and further 1.2 mass % or more and 1.8 mass % or less.

<Outer θ Phase>

Outer θ phase 532b is formed immediately above inner θ phase 531b. This outer θ phase 532b includes a layered portion formed immediately above the layered portion and the peninsula-like portion of inner θ phase 531b. Outer θ phase 532b contains Al₂Cu and does not contain Fe.

(Sea-Island Structure)

Sea-island structure 6b includes a plurality of coarse island portions 61b, a plurality of minute island portions 62b, and a sea portion 63b (FIGS. 7 and 9). The surface areas of coarse island portions 61b in welded portion 4 are increased by sea-island structure 6b, so that the stress acting on welded portion 4 is readily distributed.

<Coarse Island Portion>

Coarse island portions 61b are distributed on the side opposite to the Cu member 3 side with respect to stack structure 5b. This coarse island portion 61b contains Al₂Cu and Fe. Coarse island portion 61b contains Al₂Cu as a main component. The content of Fe is 0.05 mass % or more and 1 mass % or less, and further 0.2 mass % or more and 0.6 mass % or less. It is preferable that Fe is dissolved in Al₂Cu. The size of coarse island portion 61b is 5 μm² or more and 30 μm² or less, and further 10 μm² or more and 30 μm² or less. The method of measuring the size of coarse island portion 61b is the same as the method of measuring island portion 61a in first metal member-welded structure 1A. The suitable range of the distance between coarse island portions 61b is the same as the above-mentioned suitable distance between island portions 61a. This prevents an excessively long distance between coarse island portions 61b, so that linear propagation of cracks can be suppressed. This method of measuring the distance is the same as the above-described method of measuring the distance between island portions 61a.

<Minute Island Portion>

Minute island portions 62b are distributed among coarse island portions 61b. Among coarse island portions 61b, each minute island portion 62b is formed between coarse island portion 61b and sea portion 63b, or interspersed in sea portion 63b, that is, surrounded by sea portion 63b. This minute island portion 62b contains pure Al. Minute island portion 62b is allowed to contain Fe. The content of Fe in minute island portion 62b is 0.05 mass % or more and 1 mass % or less, and further 0.2 mass % or more and 0.6 mass % or less. It is preferable that Fe is dissolved in pure Al. The size of minute island portion 62b is 0.2 μm² or more and 1 μm² or less, and further 0.4 μm² or more and 0.7 μm² or less. The method of measuring the size of minute island portion 62b is as described above except for the magnification of the field of view and the size of the field of view. The magnification of each field of view is set at 50000 times, and the size of each field of view is set at 2.7 μm×2.7 μm.

<Sea Portion>

Sea portion 63b is interposed between coarse island portion 61b and minute island portion 62b. This sea portion 63b is formed in a three-dimensional mesh-like shape. This sea portion 63b is interposed also between coarse island portion 61b and outer θ phase 532b of stack structure 5b. Sea portion 63b contains Al₂Cu and Fe. This sea portion 63b contains Al₂Cu as a main component. The content of Fe is 0.5 mass % or more and 10 mass % or less, and further 1 mass % or more and 8 mass % or less.

[Third Metal Member-Welded Structure]

Referring to FIG. 1 and FIGS. 10 to 12, a third metal member-welded structure 1C will be hereinafter described. Third metal member-welded structure 1C is similar to first and second metal member-welded structures 1A and 1B in that it includes Al alloy member 2, Cu member 3, and welded portion 4, but is different from first and second metal member-welded structures 1A and 1B in composition and structure of welded portion 4. Third metal member-welded structure 1C can be manufactured by the above-described method of manufacturing a metal member-welded structure in the same manner as with first and second metal member-welded structures 1A and 1B.

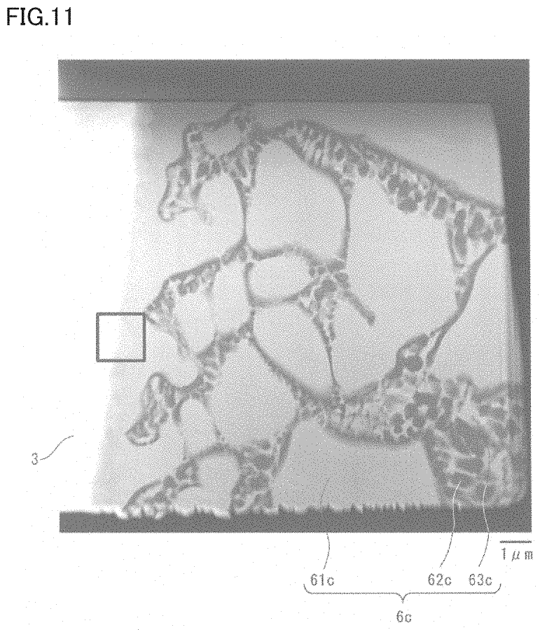

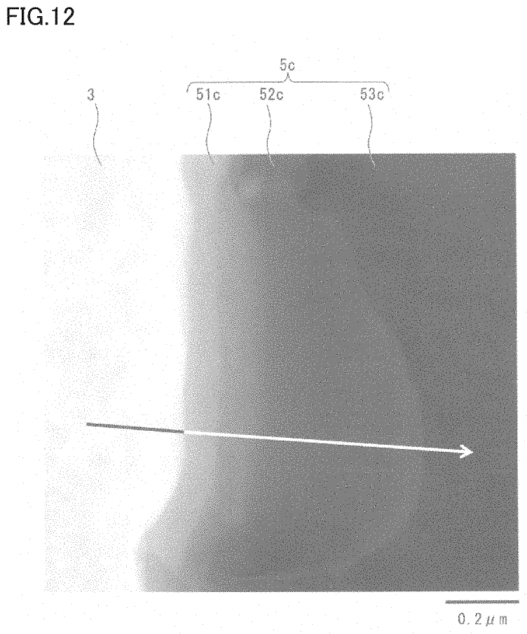

As in FIGS. 2 and 6, FIG. 10 is a microphotograph showing, in an enlarged manner, a portion surrounded by a broken line circle in FIG. 1 and also showing, in an enlarged manner, a portion at and around the interface of welded portion 4 with Cu member 3. FIG. 11 is a microphotograph showing, in an enlarged manner, a portion of sea-island structure 6c in FIG. 10 on the Cu member 3 side. FIG. 12 is a transmission electron microscope photograph, in an enlarged manner, a region surrounded by a solid line rectangle in FIG. 11.

[Al Alloy Member]

Al alloy member 2 contains Al as a main component and is formed of an Al-based alloy containing Mn as an additional element (FIG. 1). This Al alloy member 2 is allowed to contain inevitable impurities. The content of Mn is as described above and is 0.05 mass % or more and 2.5 mass % or less, preferably 0.25 mass % or more and 2 mass % or less, and further preferably 0.5 mass % or more and 1.5 mass % or less.

[Welded Portion]

Welded portion 4 includes stack structure 5c, sea-island structure 6c, and lamellar structure 7 (FIG. 10) in the same manner as with first and second metal member-welded structures 1A and 1B. This welded portion 4 is different from first and second metal member-welded structures 1A and 1B in that the main constituent elements of welded portion 4 are Al, Mn, and Cu and in composition and structure of each of stack structure 5c and sea-island structure 6c.

(Stack Structure)

Stack structure 5c is formed by stacking a γ₂ phase 51c, a β phase 52c, and a θ phase 53c sequentially in this order in the direction away from the interface with Cu member 3 (FIG. 12).

<γ₂ Phase>

First, γ₂ phase 51c is formed in a layered shape immediately above Cu member 3. This γ₂ phase 51c contains Cu₉Al₄ and does not contain Mn. The thickness of γ₂ phase 51c is 0.05 μm or more and 0.5 μm or less, and further 0.1 μm or more and 0.3 μm or less.

<β Phase>

Then, β phase 52c is formed in a layered shape immediately above γ₂ phase 51c. This β phase 52c contains Cu₃Al and Mn. (3 phase 52c contains Cu₃Al as a main component. The content of Mn is 0.3 mass % or more and 2.3 mass % or less, and further 0.8 mass % or more and 1.8 mass % or less. The thickness of β phase 52c is 0.05 μm or more and 0.5 μm or less, and further 0.1 μm or more and 0.3 μm or less.

<θ Phase>

Then, θ phase 53c is formed immediately above β phase 52c. This θ phase 53c includes a layered portion formed on the β phase 52c side, and a peninsula-like portion extending from a part immediately above this layered portion to the side opposite to β phase 52c. This θ phase 53c contains Al₂Cu and does not contain Mn.

(Sea-Island Structure)

Sea-island structure 6c is the same as second metal member-welded structure 1B in that it includes a plurality of coarse island portions 61c, a plurality of minute island portions 62c, and a sea portion 63c, but is different from second metal member-welded structure 1B in that the type of the element contained in each of coarse island portion 61c and sea portion 63c is not Fe but Mn (FIG. 11). In other words, coarse island portion 61c contains Al₂Cu and Mn. The content of Mn is 0.05 mass % or more and 1 mass % or less, and further 0.2 mass % or more and 0.6 mass % or less. It is preferable that Mn is dissolved in Al₂Cu. Coarse island portion 61c has the same size as that of the above-described coarse island portion 61b. Minute island portion 62c contains pure Al. Minute island portion 62c is allowed to contain Mn. The content of Mn in minute island portion 62c is 0.05 mass % or more and 1 mass % or less, and further 0.2 mass % or more and 0.6 mass % or less. It is preferable that Mn is dissolved in pure Al. Minute island portion 62c has the same size as that of the above-described minute island portion 62b. In the same manner as with sea-island structure 6b in second metal member-welded structure 1B, the surface area of coarse island portion 61c in welded portion 4 is increased by this sea-island structure 6c, so that the stress acting on welded portion 4 is readily distributed.

[Uses]

First to third metal member-welded structures 1A to 1C each can be suitably utilized for various types of bus bars and vehicle-mounted battery modules.

[Functions and Effects]

First to third metal member-welded structures 1A to 1C allow excellent joining strength between Al alloy member 2 and Cu member 3.

### Test Example 1

A metal member-welded structure was fabricated and its joining strength was evaluated.

[Samples No. 1-1 to No. 1-3]

The metal member-welded structures of samples No. 1-1 to No. 1-3 were fabricated through the preparing step and the welding step in the same manner as with the above-described method of manufacturing a metal member-welded structure.

[Preparing Step]

An Al alloy member and a Cu member were prepared. As Al alloy members of respective samples, Al alloy members (having a thickness of 0.6 mm) having the following compositions were prepared. As Cu members of respective samples, plate members (having a thickness of 0.3 mm) made of pure copper were prepared.

An Al alloy member of sample No. 1-1: an Al—Si alloy containing 5 mass % of Si

An Al alloy member of sample No. 1-2: an Al—Fe alloy containing 1 mass % of Fe

An Al alloy member of sample No. 1-3: an Al—Mn alloy containing 1 mass % of Mn

[Welding Step]

The Al alloy member and the Cu member were disposed to face each other, to which laser was applied from the Al alloy member side, thereby welding the Al alloy member and the Cu member to each other. The laser applying condition is as follows.

(Applying Condition)

Output: 800 W

Scanning rate: 30 mm/sec

[Samples No. 1-101 to No. 1-103]

The metal member-welded structures of samples No. 1-101 to No. 1-103 were fabricated in the same manner as with samples No. 1-1 to No. 1-3 except that samples No. 1-1 to No. 1-3 were welded by resistance heating.

[Sample No. 1-104]

The metal member-welded structure of sample No. 1-104 was fabricated in the same manner as with samples No. 1-1 to No. 1-3 except that an Al member made of pure Al was prepared in place of an Al alloy member.

[Analysis of Composition and Structure]

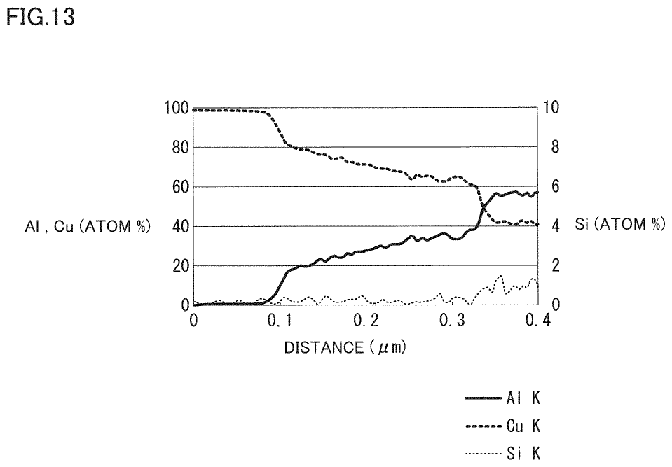

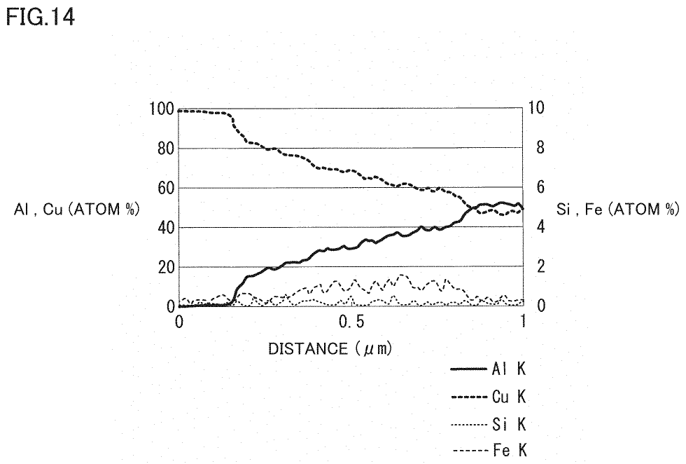

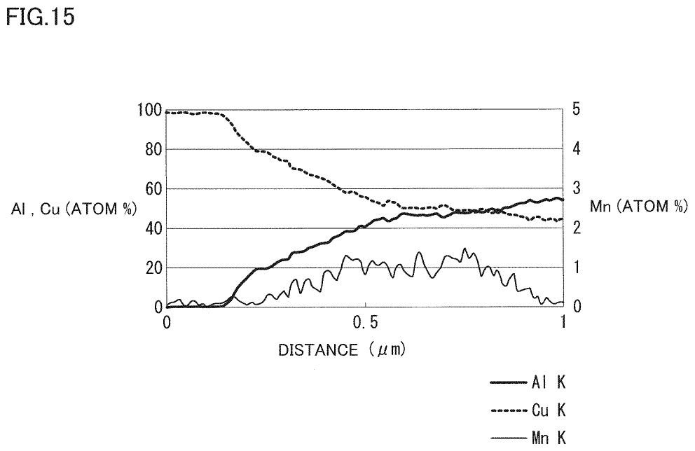

The composition and the structure of the welded portion in the metal member-welded structure of each sample were analyzed. The results about samples No. 1-1 to No. 1-3 are shown in graphs in FIGS. 13 to 15. In this case, a line analysis for the portion at and around the interface with the Cu member in the welded portion of each sample was conducted by the EDX (SEM: S-3400N manufactured by Hitachi High-Technologies Corporation). The line analysis range is indicated by rectangle frames and an arrow shown in the microphotographs in FIGS. 4, 8 and 12. In each of the graphs in FIGS. 13 to 15, the horizontal axis shows the distance (μm) from the left end of the line (a rectangle frame and an arrow); the vertical axis on the left side shows the atoms (at) % in the detected Al and Cu elements; and the vertical axis on the right side shows the atoms (at) % in the detected Si, Fe and Mn elements. The left end of the horizontal axis corresponds to the left end of the line analysis (the rectangle frame and the arrow) while the right end of the horizontal axis corresponds to the right end of the line analysis. In the graph in FIG. 13, a thick solid line shows Al, a thick broken line shows Cu, and a thin dotted line shows Si. In the graph in FIG. 14, a thick solid line shows Al, a thick broken line shows Cu, a thin dotted line shows Si, and a thin broken line shows Fe. In the graph in FIG. 15, a thick solid line shows Al, a thick broken line shows Cu, and a thin solid line shows Mn.

As to the metal member-welded structure of sample No. 1-1, it turned out that welded portion 4 includes stack structure 5a, sea-island structure 6a, and lamellar structure 7 as described above with reference to the microphotographs in FIGS. 2 to 5. As to sample No. 1-2, it turned out that welded portion 4 includes stack structure 5b, sea-island structure 6b, and lamellar structure 7 as described above with reference to the microphotographs in FIG. 6 to FIG. 9. As to sample No. 1-3, it turned out that welded portion 4 includes stack structure 5c, sea-island structure 6c, and lamellar structure 7 as described above with reference to the microphotographs in FIGS. 10 to 12. On the other hand, in the metal member-welded structures of samples No. 1-101 to No. 1-104, a welded portion including a stack structure and the like as in samples No. 1-1 to No. 1-3 was not formed.

[Evaluation of Joining Strength]

The joining strength of each sample was evaluated by measuring the maximum tensile force (N) obtained by pulling Al alloy member 2 and Cu member 3 in the direction perpendicular to the surfaces of Al alloy member 2 and Cu member 3 facing each other and in the direction in which Al alloy member 2 and Cu member 3 are away from each other. In this case, both members were pulled so as to peel off the welded portion in the laser scanning direction (in the longitudinal direction of the welded portion). The rate at which the welded portion was peeled off was set at 50 mm/min. The result of the maximum tensile force of each sample was defined as the lowest tensile force among the maximum tensile forces at evaluation number n=3.

The maximum tensile force of sample No. 1-1 was 24N, and the maximum tensile force of each of sample No. 1-2 and sample No. 1-3 was 22N. On the other hand, the maximum tensile force of each of samples No. 1-101 to No. 1-103 was about 18N, and the maximum tensile force of sample No. 1-104 was 12N.

This result showed that the joining strength was more excellent in the metal member-welded structure obtained by welding through application of laser on the specific applying condition to an Al alloy member prepared to contain a specific element than in the metal member-welded structure prepared by welding a member containing pure Al.

### Test Example 2

Ten metal member-welded structures of each of samples No. 2-1 to No. 2-3 and No. 2-101 to No. 2-104 that are the same as the metal member-welded structures of samples No. 1-1 to No. 1-3 and No. 1-101 to No. 1-104 were fabricated in the same manner as in test example 1. Then, each joining strength was measured by the same evaluation method as that in test example 1.

All of the maximum tensile forces of the metal member-welded structures of samples No. 2-1 to No. 2-3 showed the results similar to those of samples No. 1-1 to No. 1-3. Also, the maximum tensile forces of some (three) of the metal member-welded structures of samples No. 2-101 to No. 2-103 showed the results comparable to those of samples No. 1-1 to No. 1-3 while the maximum tensile forces of most (seven) of them showed the results similar to those of samples No. 1-101 to No. 1-103. Also, all of the metal member-welded structures of sample No. 2-104 showed the results similar to those of sample No. 1-104.

The above-described results show that, by welding through application of laser on the specific applying condition to an Al alloy member prepared to contain a specific element, a metal member-welded structure with excellent joining strength can be manufactured with stability as compared with the case where pure Al is prepared.

### Test Example 3

In each of sample No. 1-1 to sample No. 1-3, a metal member-welded structure was fabricated on twelve conditions in Table 1 showing the laser applying conditions. Then, each joining strength was measured by the same evaluation method as that in test example 1. In other words, samples No. 3-1-1 to No. 3-1-12 were fabricated in the same manner as with sample No. 1-1 except for the laser applying condition. Samples No. 3-2-1 to No. 3-2-12 were fabricated in the same manner as with sample No. 1-2 except for the laser applying condition. Samples No. 3-3-1 to No. 3-3-12 were fabricated in the same manner as with sample No. 1-3 except for the laser applying condition.

TABLE 1

| | | |
|---|---|---|
| | Output | Scanning Rate |
| Sample No. | (W) | (mm/sec) |

| | | | | |
|---|---|---|---|---|
| 3-1-1 | 3-2-1 | 3-3-1 | 550 | 15 |
| 3-1-2 | 3-2-2 | 3-3-2 | 550 | 22.5 |
| 3-1-3 | 3-2-3 | 3-3-3 | 600 | 15 |
| 3-1-4 | 3-2-4 | 3-3-4 | 600 | 30 |
| 3-1-5 | 3-2-5 | 3-3-5 | 600 | 60 |
| 3-1-6 | 3-2-6 | 3-3-6 | 600 | 90 |
| 3-1-7 | 3-2-7 | 3-3-7 | 700 | 30 |
| 3-1-8 | 3-2-8 | 3-3-8 | 700 | 60 |
| 3-1-9 | 3-2-9 | 3-3-9 | 700 | 90 |
| 3-1-10 | 3-2-10 | 3-3-10 | 800 | 30 |
| 3-1-11 | 3-2-11 | 3-3-11 | 800 | 60 |
| 3-1-12 | 3-2-12 | 3-3-12 | 800 | 90 |

The joining strength of the metal member-welded structure of each of samples No. 3-1-1 to No. 3-1-12 was comparable to that of sample No. 1-1. The joining strength of the metal member-welded structure of each of samples No. 3-2-1 to No. 3-2-12 is comparable to that of sample No. 1-2. The joining strength of the metal member-welded structure of each of samples No. 3-3-1 to No. 3-3-12 was comparable to that of sample No. 1-3.

Based on these results, it is considered that the metal member-welded structure of each of samples No. 3-1-1 to No. 3-1-12 includes welded portion 4 that has stack structure 5a, sea-island structure 6a, and lamellar structure 7 like sample No. 1-1 as described above with reference to the microphotographs in FIGS. 2 to 5. It is also considered that the metal member-welded structure of each of samples No. 3-2-1 to No. 3-2-12 includes welded portion 4 that has stack structure 5b, sea-island structure 6b, and lamellar structure 7 like sample No. 1-2 as described above with reference to the microphotographs in FIGS. 6 to 9. It is also considered that the metal member-welded structure of each of samples No. 3-3-1 to No. 3-3-12 includes welded portion 4 that has stack structure 5c, sea-island structure 6c, and lamellar structure 7 like sample No. 1-3 as described above with reference to the microphotographs in FIGS. 10 to 12.

The present invention is defined by the terms of the claims, but not limited to the above description, and is intended to include any modifications within the meaning and scope equivalent to the terms of the claims.

### REFERENCE SIGNS LIST

1 metal member-welded structure, 1A first metal member-welded structure, 1B second metal member-welded structure, 1C third metal member-welded structure, 2 Al alloy member, 3 Cu member, 4 welded portion, 5a, 5b, 5c stack structure, 51a, 51b, 51c γ₂ phase, 52a, 52b δ phase, 52c β phase, 53a, 53c θ phase, 531b inner θ phase, 532b outer θ phase, 6a, 6b, 6c sea-island structure, 61a island portion, 61b, 61c coarse island portion, 62b, 62c minute island portion, 63a, 63b, 63c sea portion, 7 lamellar structure.

1. A method of manufacturing a metal member-welded structure, the method comprising:
a preparing step of preparing an Al alloy member made of an Al-based alloy and a Cu member containing Cu as a main component; and
a welding step of applying laser from a side of the Al alloy member to the Al alloy member and the Cu member disposed to face each other, and welding the Al alloy member and the Cu member to each other, wherein
the Al-based alloy contains, as an additional element, one of: 1 mass % or more and 17 mass % or less of Si; 0.05 mass % or more and 2.5 mass % or less of Fe; and 0.05 mass % or more and 2.5 mass % or less of Mn, and
a laser applying condition satisfies
an output of 550 W or more, and
a scanning rate of 10 mm/sec or more.

2. The method of manufacturing a metal member-welded structure according to claim 1, wherein
the laser applying condition satisfies
an output of 850 W or less, and
a scanning rate of 90 mm/sec or less.

3. The method of manufacturing a metal member-welded structure according to claim 1, wherein the laser is fiber laser.

4. The method of manufacturing a metal member-welded structure according to claim 1, wherein the laser is applied to allow penetration through the Cu member.

5. A metal member-welded structure comprising:
an Al alloy member containing 1 mass % or more and 17 mass % or less of Si;
a Cu member containing Cu as a main component; and
a welded portion formed by melting and solidifying each of materials of the Al alloy member and the Cu member, wherein
the welded portion includes a stack structure formed by sequentially stacking
a γ₂ phase containing Cu₉Al₄ and not containing Si,
a δ phase containing Cu₃Al₂ and not containing Si, and
a θ phase containing Al₂Cu and Si,
in a direction away from an interface with the Cu member.

6. A metal member-welded structure comprising:
an Al alloy member containing 0.05 mass % or more and 2.5 mass % or less of Fe;
a Cu member containing Cu as a main component; and
a welded portion formed by melting and solidifying each of materials of the Al alloy member and the Cu member, wherein
the welded portion includes a stack structure formed by sequentially stacking
a γ₂ phase containing Cu₉Al₄ and not containing Fe,
a δ phase containing Cu₃Al₂ and Fe,
an inner θ phase containing Al₂Cu and Fe, and
an outer θ phase containing Al₂Cu and not containing Fe,
in a direction away from an interface with the Cu member.

7. A metal member-welded structure comprising:
an Al alloy member containing 0.05 mass % or more and 2.5 mass % or less of Mn;
a Cu member containing Cu as a main component; and
a welded portion formed by melting and solidifying each of materials of the Al alloy member and the Cu member, wherein
the welded portion includes a stack structure formed by sequentially stacking
a γ₂ phase containing Cu₉Al₄ and not containing Mn,
a β phase containing Cu₃Al and Mn, and
a θ phase containing Al₂Cu and not containing Mn,
in a direction away from an interface with the Cu member.

8. The metal member-welded structure according to claim 5, wherein
the welded portion includes a sea-island structure including:
a plurality of island portions containing Al₂Cu and Si, and distributed on a side opposite to the interface with respect to the stack structure; and
a sea portion containing pure Al and Si, and interposed among the plurality of island portions.

9. The metal member-welded structure according to claim 8, wherein a distance between the island portions is 10 μm or less.

10. The metal member-welded structure according to claim 6, wherein
the welded portion includes a sea-island structure including:
a plurality of coarse island portions containing Al₂Cu and Fe, and distributed on a side opposite to the interface with respect to the stack structure;
a plurality of minute island portions containing pure Al and distributed among the plurality of coarse island portions; and
a three-dimensional mesh-like sea portion containing Al₂Cu and Fe, and interposed between the coarse island portion and the minute island portion.

11. The metal member-welded structure according to claim 7, wherein
the welded portion includes a sea-island structure including:
a plurality of coarse island portions containing Al₂Cu and Mn, and distributed on a side opposite to the interface with respect to the stack structure;
a plurality of minute island portions containing pure Al and distributed among the plurality of coarse island portions; and
a three-dimensional mesh-like sea portion containing Al₂Cu and Mn, and interposed between the coarse island portion and the minute island portion.

12. The metal member-welded structure according to claim 10, wherein a distance between the coarse island portions is 10 μm or less.

13. The metal member-welded structure according to claim 8, wherein the welded portion has a lamellar structure containing Al₂Cu and pure Al on a side opposite to the stack structure with respect to the sea-island structure.

14. The metal member-welded structure according to claim 5, wherein the welded portion penetrates through the Cu member.

15. The metal member-welded structure according to claim 10, wherein the welded portion has a lamellar structure containing Al₂Cu and pure Al on a side opposite to the stack structure with respect to the sea-island structure.

16. The metal member-welded structure according to claim 11, wherein the welded portion has a lamellar structure containing Al₂Cu and pure Al on a side opposite to the stack structure with respect to the sea-island structure.

17. The metal member-welded structure according to claim 6, wherein the welded portion penetrates through the Cu member.

18. The metal member-welded structure according to claim 7, wherein the welded portion penetrates through the Cu member.
